(19) United States
(12) Patent Application Publication
(10) Pub. No.: US 2004/0118747 A1
(43) Pub. Date: Jun. 24, 2004

(54) Structured adsorbents for desulfurizing fuels

(76) Inventors: Willard A. Cutler, Big Flats, NY (US); Lin He, Horseheads, NY (US); Lorraine K. Owens, Bath, NY (US); Charles M. Sorensen JR., Corning, NY (US)

Correspondence Address: CORNING INCORPORATED, SP-TI-3-1, CORNING, NY, 14831

(21) Appl. No.: 10/322,182

(22) Filed: Dec. 18, 2002

(51) Int. Cl. C10G 25/00; C10G 29/04; B01D 53/34

(52) U.S. Cl. 208/208 R; 208/243; 208/244; 208/246; 208/247; 208/249; 208/300; 422/177; 422/171; 422/180

(57) ABSTRACT

Desulfurization reactors, and fuel desulfurization systems incorporating them, comprise monolithic sulfur-adsorbent reactor packings having internal void spaces bounded by internal fuel contacting surfaces that support or contain active sulfur adsorbents for sulfur trapping, the reactors providing efficient fuel feed desulfurization at high liquid and/or gas feed rates and low pressure drops.

The present invention relates to adsorbers and reactive adsorbers for the desulfurization of hydrocarbon fuel feed streams. Such reactors are useful, for example, in fuel reforming apparatus for generating hydrogen fuel for hydrogen-powered fuel cells, or in fuel delivery systems for supplying low-sulfur fuel to combustion engines, or in other systems supporting combustion processes requiring the use of low sulfur fuel.

Fuel reforming systems for generating hydrogen fuel from liquid or gaseous hydrocarbon fuel feed streams are well known. Published PCT application WO 00/66486 and published European patent application EP 967174 disclose integrated fuel reformer systems incorporating multiple interconnecting reactor sections for continuous fuel processing, while published Japanese Patent Application No. JP 2000-159502 describes miniaturized fuel reforming systems offering shortened starting times and improved energy efficiency.

Typical fuel reforming systems for processing hydrocarbon feed streams into hydrogen will comprise multiple stages or reactors for carrying out the various steps of the hydrogen generation process. A common system design comprises an initial reforming stage for producing carbon monoxide and water from an air-hydrocarbon-water feed, followed by a water-gas shift stage to generate hydrogen and carbon dioxide, followed by a preferential oxidation stage to oxidize residual carbon monoxide present in the feed prior to delivery to a fuel cell module.

Adsorbers for the removal of sulfur from hydrocarbon feed streams comprise another approach to the problem of sulfur in these feed streams. Published PCT patent application No. WO 9934912, for example, describes an adsorbent system designed to adsorb trace elements or compounds of sulfur, arsenic or mercury from olefinic or paraffinic hydrocarbon gas streams. The adsorbers comprise iron oxide and manganese oxide disposed on a support of aluminum oxide. U.S. Pat. No. 6,159,256 discloses a method for desulfurizing a hydrocarbon feed steam consisting of a liquid or gaseous hydrocarbon fuel stream containing relatively high levels of organic sulfur compounds such as mercaptans or sulfides. The method comprises passing the feed stream over a nickel desulfurization bed to convert the sulfur compounds to nickel sulfides.

Problems with conventional sulfur adsorbing systems include high adsorber back-pressures that limit fuel flow rates and/or add fuel penalties to system operation. Such systems also generally exhibit lower than desired adsorbent surfaces areas, low surface to volume ratios, and high thermal mass, all of which reduce adsorbent efficiency and slow reactor response times.

### SUMMARY OF THE INVENTION

The present invention provides an improved method and device for removing sulfur from fuels to be used in spark ignition applications, compression ignition applications or for fuel-reforming systems. The invention further includes desulfurizing reactors of improved efficiency for the removal of organic or inorganic sulfur compounds from hydrocarbon fuels or partially reformed fuel streams. Reforming systems comprising these reactors can be used for the treatment of a variety of hydrocarbon fuel feed streams in either the liquid or gaseous state, examples of such feed streams including natural gas, methanol, gasoline, diesel fuel, naphtha and the like.

The desulfurizing reactors of the invention comprise novel structured regenerable sulfur removal adsorbents or reactive adsorbents. These are monolithic adsorbent structures comprising internal void spaces bounded by internal adsorption surfaces, the internal surfaces supporting or containing an active sulfur adsorbent, e.g., a reactive adsorbent, for extracting sulfur from a sulfur-containing fuel stream flowing through the internal void spaces. A preferred example of such a structure is an extruded honeycomb structure wherein the internal void spaces comprise through-channels bounded by reactive adsorbent walls. The walls support one or more reactive compounds or elements that combine with and extract sulfur compounds from the feed stream. The reactive adsorbents or catalyst/adsorbents are effective to catalytically free sulfur from a variety of organic or inorganic sulfur-containing compounds present in small concentrations in hydrocarbon fuel feeds, then trapping the released sulfur by adsorption or reactive binding.

Monolithic adsorbent structures permit the processing liquid or gaseous feed streams at high feed rates and low pressure drops, while still achieving large reductions in sulfur concentration in the treated feed streams. Monolithic adsorbent structures such as, for example, honeycomb structures provide substantial adsorbent volumes at increased adsorbent surface/volume ratios, effectively increasing mass transfer rates and thereby significantly reducing reactor response times.

The desulfurizing reactors of the invention can be positioned at one or multiple locations within a selected fuel delivery or fuel reforming system, depending upon the particular system design being employed. Typically such reactors will be positioned upstream of the fuel reforming stage since many fuel reforming catalysts are vulnerable to poisoning by sulfur compounds in the feed stream. Some reforming systems may optionally employ an additional desulfurizing reactor upstream of the water-gas shift stage of the system, since certain water-gas shift catalysts are also susceptible to deactivation by sulfur.

The structured adsorbents utilized in the invention can be of regenerating or non-regenerating type, depending upon the particular material used to construct the adsorbent. In either case, substantial removal of organic or inorganic sulfur species such as mercaptans, thiophenes, benzothiophenes, sulfides (e.g., hydrogen sulfide), disulfides, sulfones, sulfur oxides, carbonyl sulfide, and elemental sulfur from fuel-based feed streams can rapidly and efficiently be accomplished. For example, using these adsorbents, compact desulfurizing reactors can readily be designed that provide at least 70% removal of the above sulfur species from liquid fuel feed streams at liquid hourly space velocities (LHSV) of 1 hr⁻¹, or from vapor-phase fuel feed streams at gas hourly space velocities (GHSV) of 500 hr⁻¹. With the more efficient sulfur adsorbents, reactor operation at LHSV values of 5 hr⁻¹ or more, or GHSV values of at least 500 hr⁻¹ will still permit removal rates of 70% or higher. And, the removal of sulfur to below 1 ppm from commonly available feeds such as gasoline can be realized in appropriately designed reactors employing structured adsorbents at these feed rates.

In addition to utility for hydrogen generation in both stationary and mobile fuel cell power systems, the desulfurizing reactors of the invention can also be used to process liquid or gaseous fuels for combustion engines requiring low-sulfur fuels. These include engines provided with catalytic nitrogen oxide emissions control systems that employ sulfur-intolerant catalysts. The reactors are also suitable for use in hydrogen generation systems for the chemical processing industry where hydrogen is needed as a reactant or as an additive.

### DESCRIPTION OF THE DRAWINGS

The invention may be further understood by reference to the drawings, wherein

FIG. 1 presents a schematic illustration of a fuel reforming system incorporating a desulfurizing reactor according to the invention;

FIG. 2 is a schematic illustration of a fuel desulfurizing reactor according to the invention;

FIG. 3 illustrates a section of a wall flow monolithic sulfur adsorbent structure useful in accordance with the invention; and

FIG. 4 compares the pressure drop characteristics of packed bed and monolith adsorbent types useful for the desulfurizing treatment of gas and liquid fuel streams

### DETAILED DESCRIPTION

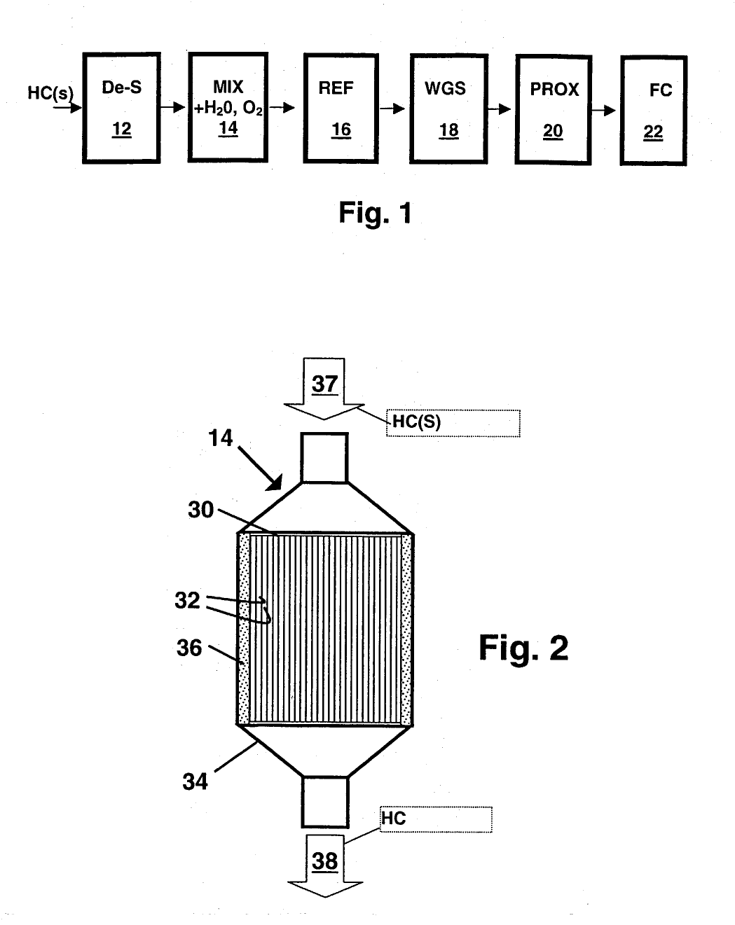

Referring more particularly to the drawing, a fuel reforming system incorporating a desulfurizing (DeS) reactor 12 in accordance with the invention is schematically illustrated in FIG. 1, although not in true proportion or to scale. That system includes a mixing (MIX) chamber 14 downstream of desulfurizing reactor 12 for mixing the desulfurized feed stream of hydrocarbon fuel with water and air to be processed through the system. The desulfurized fuel, air and water mixture being discharged from mixer 14 is then fed to a fuel reforming (REF) stage 16 of the system, that stage generating hydrogen and carbon monoxide from the hydrocarbon fuel present in the feed, most typically through one or a combination of autothermal reforming, steam reforming, and partial oxidation processes.

The reformed feed stream is next fed to a water gas shift (WGS) reaction stage 18 for generating hydrogen from the carbon monoxide and water vapor present in the feed. This stage incorporates high-temperature or low-temperature shift catalysts, or combinations thereof, and may comprise more than one reactor in some systems.

Finally, a preferential CO oxidization (PROX) reactor 20 is provided for oxidizing residual carbon monoxide present in the feed prior to transferring the processed feed to an electrically generating fuel cell (FC) device 22. The fuel cell device could consist of a proton exchange membrane fuel cell, a solid oxide fuel cell, or another fuel cell system requiring a hydrogen-enriched feed gas for the fuel. An optional system component not shown in FIG. 1 could comprise an additional desulfurizing reactor positioned between the fuel reformer 16 and the water-gas shift stage 18, where a water-gas shift catalyst particularly prone to sulfur poisoning is being employed.

FIG. 2 of the drawing is a schematic elevational cross-sectional view of a desulfurizing reactor 14 provided in accordance with the invention. In that illustration, a structured sulfur adsorbent consisting of a honeycomb 30 comprising a plurality of walled through-channels 32 is supported within a treating vessel 34 by a packing material 36. A fuel feed stream indicated by inlet arrow 37 comprising a sulfur-containing fuel HC(S), enters the top of vessel 34 and is processed through honeycomb 30. In the discharge stream exiting the reactor and indicated by arrow 38, the treated hydrocarbon fuel (HC) product has been treated to remove the sulfur.

A structured sulfur adsorbent useful in desulfurizing reactors provided in accordance with the invention may be broadly characterized as a structure comprising internal void spaces (channels, open cavities or the like) within which a fuel feed stream entering the structure for treatment will come into contact with active adsorbing species disposed on or within the walls of the void spaces. The preferred structured adsorbents are of honeycomb configuration, comprising a plurality of parallel through-channels running from an entrance to an exit face of the structure and separated by channel walls containing the adsorbent material. The honeycombs may be formed of a reactive adsorbent, or the adsorbent may be disposed on or within the channel walls, e.g. as a coating. Other forms for structured adsorbents include foamed or reticulated bodies.

One specialized honeycomb structure particularly useful as a sulfur adsorbent for certain applications is a wall-flow filter body wherein fluid flow is directed through the channel walls of the honeycomb. Honeycomb wall flow filters, presently in commercial use as gas filters for stack gas and motor vehicle exhaust emissions control, comprise honeycombs incorporating a distributed array of inlet channels alternating with an interspersed array of adjoining outlet channels. The inlet channels are blocked by plugging at the honeycomb exit face and the outlet channels by plugging at the entrance face, such that fluids entering the inlet channels must traverse channel walls to exit the structure through the outlet channels. Structured wall-flow adsorbents provide for increased contact efficiency and may be particularly useful, for example, in some liquid desulfurization processes where slow desulfurizing reaction kinetics are involved.

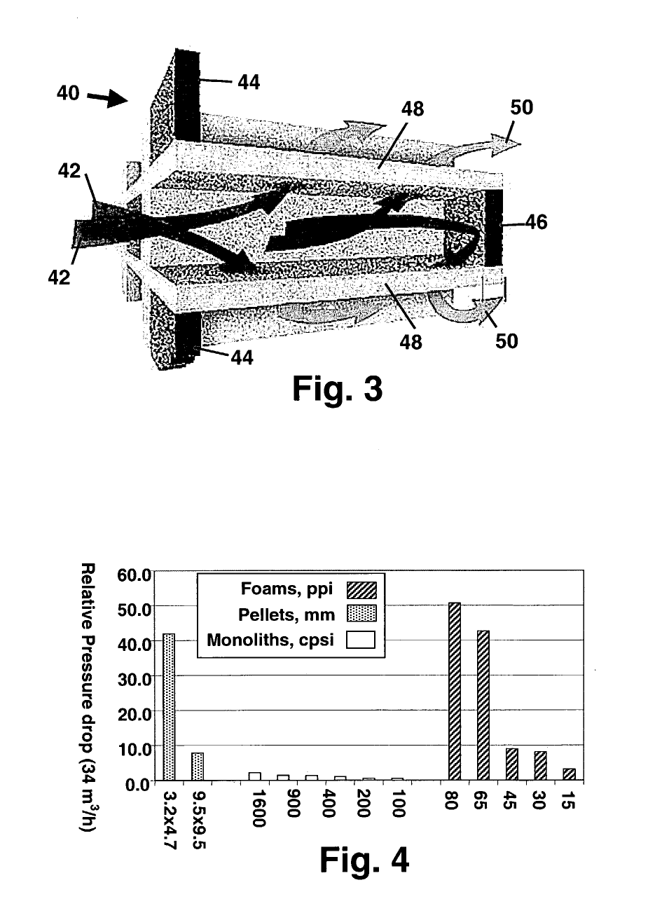

The operation of such a wall flow adsorbent is schematically illustrated in FIG. 3 of the drawings, which presents a partial perspective cutaway view of a section 40 of such an adsorbent. In the operation of such an adsorbent, fuel stream segments such as indicated by arrows 42, made up of a liquid or gaseous sulfur-containing fuel to be treated, enter so-called inlet channels within adsorbent 40. The inlet channels are those channels not blocked by entrance plugs 44.

Fuel within these inlet channels, being denied direct egress from adsorbent structure 40 by outlet plugs 46 in those channels, is forced to traverse porous, sulfur-adsorbing walls 48 of the structure to reach the adjoining outlet channels of structure 40. The outlet channels are those channels covered by entrance plugs 44 but not blocked by discharge plugs 46. The resulting desulfurized fuel streams 50 then exit the structure from the outlet channels.

For gas-phase desulfurizing processes or where low reactor back-pressures are required, straight-flow or so-called flow-through monoliths providing structured adsorbents with no blocked channels or cavities can be used. Again, honeycomb monoliths for these applications may be directly extruded from reactive adsorbent materials, or the materials can be deposited on the channel walls of suitable supporting honeycomb structures by washcoating or the like.

The geometric parameters of structured adsorbents of monolithic honeycomb configuration provided in accordance with the invention will be selected based on the particular application or environment in which the honeycombs are to operate. Extruded honeycomb cell densities can range from 50 to 3000 channels/in² of honeycomb cross-section, and honeycomb web or channel wall thickness then varied in accordance with the amount of adsorbent material required and the backpressure level that can be tolerated for a particular application.

Table 1 below sets forth geometric surface area (GSA), open frontal area (OFA) and channel hydraulic diameter (Dₕ) data for extruded honeycombs within a preferred range of geometric design space considered suitable for liquid- or gas-phase desulfirization processes, for the case where the honeycomb itself is formed entirely of a sulfur-adsorbent material.

TABLE 1
Honeycomb Properties

| | | | | | |
|---|---|---|---|---|---|
| Cell density (cpsi) | 100 | 200 | 400 | 800 | 1800 |
| Wall thickness (mil) | 18 | 22 | 8 | 12 | 8 |
| OFA (open | 0.671 | 0.475 | 0.706 | 0.436 | 0.436 |
| fraction) | | | | | |
| GSA (cm²/cc) | 12.9 | 15.3 | 26.5 | 29.4 | 44.1 |
| Dₕ (mm) | 2.08 | 1.24 | 1.07 | 0.59 | 0.40 |

To achieve the desired packing density, honeycomb adsorbent structures having cell densities of at least 100 cpsi (cells/inch² of honeycomb cross-section), more preferably at least 200 cpsi, should be used. At the same time, to maintain low reactor back-pressure, the open frontal area (OFA) of the adsorbent honeycomb structure should be in the range of 30-85% of the total area of the honeycomb entrance face. Utilizing honeycombs of these geometries in well-designed desulfurizing reactors will readily permit high levels of sulfur removal at liquid hourly space velocities up to and exceeding 5 hr⁻¹, or gas hourly space velocities of 500-2000 hr⁻¹ or higher through the reactor.

The specific materials to be utilized for supporting sulfur removal reactions in these structured adsorbents include many of the materials employed in conventional sulfur extraction bead or pellet beds. Most widely used are reactive metals, or oxides of reactive metals, selected from the group of Mn, Fe, Zn, Co, Ni, Mo, Cu, Cr, W, Ag and combinations thereof. Both carbon and zeolite have also been used as adsorbers, both alone and in combination with one or more of these reactive metals or metal oxides.

Examples of compounds that are particularly effective for use in the structured adsorbents of the invention are oxide-supported nickel metal, alumina-supported Co/Mo oxides, ZnO, and activated carbon- or zeolite-supported metals. Some of these are particularly amenable to shaping into monolithic honeycomb structures by extrusion or other processes, while others are better employed as coatings on largely inert monolithic supports. In either case, any of a variety of honeycomb channel shapes including square, rectangular, hexagonal, round, etc. may be used.

The adsorption capacity or material packing density of structured adsorbents to be used for fuel desulfurization should normally be as large as possible in order to extend the interval between reactor startup and reactor shut-down or recycling for reconditioning or replacement of the adsorbent. In the case of structured honeycomb adsorbents, therefore, designs with high cell density (high channel count per unit of honeycomb cross-section) and relatively thick channel walls to increase sulfur carrying capacity offer an advantage. Where the adsorbent is to be disposed as a channel wall coating within the channels of a supporting honeycomb structure, a relatively thin-walled honeycomb support structure provided with a thick wall coating of adsorbent material can be provided.

Operation of these reactors in either the liquid phase or vapor phase regime is possible depending upon the particular fuel material to be processed and the reforming system to be utilized for that processing. In some cases, vapor phase processing of feedstocks that are liquids at ambient temperatures may be useful for some applications, and in those cases elevated temperature operation of the desulfurizing reactor may be desired. With an appropriate selection of the composition of the structured adsorbent to be utilized, reactor operating temperatures ranging from below ambient (25° C.) to 400° C. or higher are routinely useable, the higher temperature capability being such that the vapor phase desulfurization of most fuel feedstocks can be conducted whenever found appropriate.

The following examples, which are intended to be illustrative rather than limiting, provide more detailed information concerning specific embodiments of the invention.

### EXAMPLE 1

### Structured Adsorbent Preparation

Structured sulfur adsorbents composed of commercially available sulfur removal catalysts can be fabricated by a honeycomb extrusion process. Plasticized extrusion batches incorporating a commercial nickel/nickel oxide-based sulfur removal catalyst/adsorbents are first prepared. The catalyst/adsorbent used is commercially available as C-28 catalyst from Sud-Chemie Incorporated, Louisville, Ky. It is a pelletized catalyst having a composition of about 25-35 amorphous silica, 20-30% nickel, 20-30% NiO, 5-15% aluminum oxide, and 0.1-2% quartz by weight. It is converted to a powder by crushing, and then grinding and/or milling the crushed material to −200 mesh U.S. Sieve, with the resulting powder having an average particle size of about 23 μm.

Several extrusion batches comprising this catalyst powder are next compounded. Examples of representative batch types are reported in Table 2 below, all batch compositions there being reported in parts by weight of the final batch mixture. Each batch comprises a catalyst powder, water, and a cellulosic temporary extrusion binder of methyl cellulose composition. For these particular batches the methyl cellulose binder consists of Methocel® A4M cellulose binder from the Dow Chemical Company, Midland Mich. In some cases extrusion aides such as oleic acid, lubricants such as metal stearate soaps, and/or permanent binders such as colloidal alumina are also employed. Extrudates of various outer diameters (OD) are formed, dried and fired, with the extrudate diameters also being reported in Table 2.

TABLE 2
Extrusion Batches

| Extrusion | Extrudate | |
|---|---|---|
| Batch | OD | |
| Number | (inches) | Batch Composition (parts by weight) |
| 1 | 0.75 | 100 parts catalyst/adsorbent powder; |
| | | 5 parts methyl cellulose binder; |
| | | 5 parts alumina binder; 30 parts |
| | | oleic acid emulsion; |
| | | 42.5 parts deionized water. |
| 2 | 0.75 | 70 parts catalyst/adsorbent powder; |
| | | 14 parts oleic acid emulsion; 3.5 parts |
| | | cellulose binder; 37 parts water |
| 3 | 5.66 | 80 parts catalyst/adsorbent powder; |
| | | 5.6 parts cellulose binder; 0.8 parts |
| | | stearate lubricant; 54.5 parts water |

The alumina binder included in selected batches from Table 2 consists of Dispal™ 18N4 alumina powder, comprising about 80% alumina by weight and being commercially available from the CONDEA Vista Company of Houston, Tex. The oleic acid emulsion extrusion aide contains about 7.5 g triethanol amine and 50 g oleic acid per 1000 g of deionized water. The stearate lubricant is a LIGA metal stearate soap derived from tallow/cocinic acid and is commercially available from Peter Greven Fett-Chemie GmbH & Co. KG, Germany.

Extrusion batches of the above compositions are prepared by first dry-blending all dry ingredients in a Turbula or Littleford mixer to achieve homogeneous powder mixing. The dry mixture is then transferred to a muller mixer, and water and the liquid extrusion aides are then mixed into the batch for a time sufficient to achieve a plastic extrusion consistency. Finally, the plasticized extrusion batches are transferred to a ram extruder for extrusion through a honeycomb extrusion die to form wet green extruded honeycombs of the catalysts.

Following extrusion the wet green adsorbent honeycombs are slowly dried to avoid cracking, and then consolidated by heating to remove temporary binders and activate the permanent binders. A suitable slow drying method comprises gradual drying in a heated, controlled humidity enclosure at a rate sufficiently low to avoid crack formation in the honeycombs. For example, small honeycombs can be dried in a humid atmosphere by heating at 90° C. over a drying interval of 96 hours. Larger honeycomb may be suitably be dried over drying intervals of several days at temperatures in the 55-60° C. range and at relative humidities of 50-95%. Alternatively, microwave and/or vacuum drying can be employed. The actual drying treatment to be preferred in each case depends on the water content as well as the concentration and composition of vaporizable organics in the extruded honeycombs, but can readily be determined by routine experiment.

Obtaining crack-free fired adsorbent honeycombs requires some attention to heating rates and heating temperatures as well as to the firing atmospheres used and the compositions and concentrations of extrusion aides and binders present in the dried honeycombs that are not removed in the course of the drying process. For these particular honeycombs, peak firing temperatures not exceeding 350° C. are sufficient to achieve good permanent binding and adequate strength in the honeycomb products. Heating rates on the order of 20° C./hour with Intermediate holding intervals of several hours at each of 100° C., 200° C. and 300° C. in air or, optionally, nitrogen, are normally sufficient to reduce any honeycomb cracking in greenware of the above batch compositions to negligible levels. The best firing treatments for each batch example shown in Table 2 can readily be determined by routine experiment, but for the smaller extrudates from the batches reported in Table 2, a firing schedule comprising heating and cooling rates of 25° C./hour and a 10-hour hold at 350° C. produces good results.

Typical properties for selected honeycomb monoliths produced from the batch compositions above described are compared with the properties of the commercial pelletized adsorbent starting material in Table 3 below. Included for the each honeycomb adsorbent example in Table 3 are the Extrusion Batch number from Table 2, an Extrusion Run number, and the cell geometry of the extruded honeycomb, including the honeycomb cell density in channels per in² and honeycomb channel wall thicknesses in inches. Additionally reported in Table 3 are channel wall porosities for the fired honeycombs, including total pore volume as a percent, median pore diameter in micrometers, and the surface areas of the material forming the channel walls of the fired honeycombs in m²/g, after firing in accordance with the honeycomb firing schedules reported above.

TABLE 3

| | Extru- | | | | | |
|---|---|---|---|---|---|---|
| | sion | | Ex- | | | |
| | Batch | Ex- | truded | | | |
| | No./ | truded | Cell | | | |
| | Extru- | Cell | Wall | | Mean | Fired |
| | sion | Density | Thick- | | Pore | Surface |
| Adsorbent | Run | (cells/ | ness | % Wall | Diameter | Area |
| Structure | No. | in²) | (inches) | Porosity | (um) | (m2/g) |
| Pellets | | — | — | 38.86 | 0.0475 | 293.1 |
| Honeycomb | 1/1 | 200 | 0.022 | 27.32 | 0.0470 | 247.3 |
| Honeycomb | 1/1 | 100 | 0.018 | 30.19 | 0.0444 | 247.4 |
| Honeycomb | 1/1 | 1800 | 0.008 | 30.47 | 0.0454 | 260.3 |
| Honeycomb | 1/2 | 100 | 0.018 | 32.3 | 0.0465 | 212.6 |
| Honeycomb | 1/2 | 1800 | 0.008 | 38.79 | 0.0541 | 252.4 |
| Honeycomb | 1/3 | 200 | 0.022 | 31.37 | 0.0313 | 244.1 |

While the sulfur removal efficiency of monolithic nickel-oxide based sulfur removal catalysts or adsorbents such as those of Table 3 above can be quite high, there are certain applications requiring low processing pressure drop where less extensive sulfur removal is required. We find that effective sulfur removal can be achieved even in reactor designs wherein the monolithic adsorbent consists of a relatively thin coating layer of sulfur adsorbent material disposed on the contact surfaces of an otherwise inert structured ceramic support.

### EXAMPLE 2

### Coated Structured Adsorbent

To demonstrate the advantages of honeycomb monolithic trap configurations of coated honeycomb type, a hydrocarbon desulfurizing fuel treater employing a monolithic sulfur adsorbent consisting of an inert honeycomb provided with a surface coating of an active sulfur adsorbent is constructed. The monolithic adsorbent is a cylindrical ceramic honeycomb of 400 cpsi cell density, 0.18-mm channel wall thickness, 5 cm diameter and 76 cm length, provided with a high-surface-area alumina washcoat containing a solution-impregnated nickel nitrate adsorbent precursor. The solution-impregnated honeycomb is dried and calcined to convert the nickel nitrate to nickel oxide, and the oxide is then reduced to nickel in flowing hydrogen gas at 3.5 bar_{g} pressure by heating from ambient to 400° C. at _{2°} C./min and then holding at 400° C. for 16 hours. The monolithic sulfur catalyst/adsorber thus provided has a mass of about 1300 g, including about 1.7% by weight of reactive nickel metal adsorbent evenly dispersed throughout the alumina washcoat. The washcoat has a surface area of about 12.3 m²/g,

A reactor/fuel treater containing this monolith is used to treat a sulfur-containing hydrocarbon fuel feed stream composed of a raw pyrolysis gasoline obtained from a steam cracking unit. The pyrolysis gasoline contains about 22 ppm of sulfur by weight. The monolith is loaded into a reactor vessel and a 1400 liter volume of the raw pyrolysis gasoline is continuously circulated over the monolith at a temperature of 65° C., a pressure of 15 bar_{g}, and a liquid flow rate of 1320 L/hr, that flow rate corresponding to a liquid hourly space velocity of about 880 hr⁻¹.through the reactor. Hydrogen gas is co-fed to the process to minimize catalyst coking from highly unsaturated hydrocarbons present in the feed.

After 21 hours on stream, the pyrolysis gasoline flow is stopped and the fuel treater is cooled to room temperature for removal of the honeycomb monolith and analysis of the sulfur adsorption rate. About 1.3 gm of sulfur is recovered from the channel walls of the monolith.

The level of performance demonstrated by this coated monolith, although much lower than obtainable utilizing monoliths formed entirely of sulfur adsorbents (e.g., as in the monoliths comprising 20-30% nickel and 20-30% NiO of Example 1), is acceptable given the relatively low nickel loading of the monolith and the high liquid hourly space velocity employed in this process. Yet coated monolithic adsorbents of this design offer the particular advantage of very high structural strength, a feature that is especially important where physically demanding operating conditions may be involved.

The pressure drop advantage of honeycomb monolith adsorbents of the above configuration over a pellet bed catalyst/adsorbent of identical chemical composition can be calculated using conventional modeling approaches. Such approaches include the well known Ergun equation for pressure drops over packed beds and the Hagen-Poisseuille equation for pressure drops over monolithic beds.

One useful modeling comparison, scaled approximately to the capacity of the honeycomb adsorbent of Example 2 above, is set out in Table 4 below. The comparison provided is for a model liquid having flow characteristics similar to those of gasoline. Included in Table 4 are the treater design and processing conditions for the analysis, as well as geometric parameters for each of the two identically composed catalysts. The pelletized catalyst modeled for the pellet bed is of right circular cylindrical pellet shape.

TABLE 4
Liquid Fuel Desulfurization Process Model
Fuel Treater Design and Operation

| | |
|---|---|
| Treating Vessel Diameter, cm | 5 |
| Treating Vessel Length, cm | 76 |
| Liquid Fuel Flow Rate, L/h | 1320 |
| Liquid Density, g/cm³ | 0.75 |
| Liquid Viscosity, Pa s @ 65° C. | 3.53e-4 |
| Processing Pressure, bar_{g} | 15 |
| Processing Temperature, ° C. | 65 |

Catalyst Bed Comparison

| Pellet Catalyst case | Monolith Catalyst Case |
|---|---|
| Pellet Diameter (Cylinder): 1.6 mm | Cell Density: 400 cells/in² |
| | Channel wall thickness: 0.18 mm |
| Bed void fraction: 0.35 | Bed void fraction: 0.73 |
| Pressure Drop (bar_{g}): 2.6 | Pressure Drop (bar_{g}): 0.02 |

As the modeling data in Table 4 suggest, the pressure drop over the monolithic catalyst/adsorbent is over two orders of magnitude lower than that of the pellet bed at comparable catalyst volumes, even at the relatively high monolith cell density of 400 cpsi used for the comparison. Lower pressure drop at equivalent catalyst volume represents a substantial processing advantage for both liquid and vapor fuel processing systems.

The orders-of-magnitude pressure drop advantage provided by the honeycomb adsorbent above is not a special case. Honeycomb monoliths in general exhibit much lower pressure drops than other catalyst forms at equivalent geometric surface area. FIG. 4. of the drawings plots relative pressure drop values over adsorbent beds of equal volume at a standard liquid flow rate of 34 m³/hour for a number of different pellet bed, honeycomb, and foam monolith adsorbent designs. The pellets are of two sizes (pellet dimensions in mm), the honeycomb beds are of five different cell densities, in cells/in² of honeycomb cross-section (cpsi), and the porous foam monoliths are of five different foam pore diameters in pores/in³ (ppi).

The honeycomb monoliths clearly show the lowest pressure drop per volume for the various structures tested. Moreover, increasing the honeycomb cell density to increase the geometric surface area of the beds does not change bed pressure drop as significantly do design changes in the other media. In general, given constant honeycomb length, open frontal area, gas viscosity and volumetric flow rate, the pressure drop of these monolith adsorbents increases with increasing cell density, and decreases with decreasing wall thickness if cell density is kept constant. Thus monoliths are one of the most efficient methods available to pack high adsorbent surface area into a small volume while still maintaining a low pressure drop.

### EXAMPLE 3

### Metal, Metal Oxide, and Molecular Sieve Adsorbent Structures

In addition to nickel/nickel oxide reactive adsorbents, various other metal and metal oxide sulfur adsorbents may adapted for use as honeycombs in desulfurizing reactors in accordance with the invention. For example, there are a number of high-surface-area materials known to be effective for trapping sulfur and/or sulfur compounds that can offer particularly efficient desulfurizing activity for gas-phase fuel feed processing. Representative examples of such materials include metal-loaded activated carbon, various zeolitic or molecular sieve materials, and certain high-surface-area metal oxides both with and without added reactive metal phases.

Metal-loaded activated carbon adsorbents include those consisting of a combination of copper metal and chromium oxide dispersed on an activated carbon carrier. A particular example of such a material is a commercially available pelletized Cu—Cr-active carbon adsorbent (Calgon Carbon Corporation) having a composition that includes about 85-93% activated carbon, 3-6% chromium trioxide, and 4-9% copper metal.

Conventional metal oxide sulfur adsorbents include pelletized adsorbents comprising zinc oxide as the reactive sulfur adsorbent material (hereinafter Adsorbent D). Examples of such products include the zinc-oxide based adsorbent pellets such as those commercially available from Sud Chemie, Incorporated. Typical properties for pelletized zinc oxide adsorbents include pellet porosities of 50%, mean pore diameters of 0.03 um, a pore intrusion volume of 0.25 ml/g and a surface area of 52 m²/g.

Sulfur adsorbents combining zinc oxide with metallic copper additions are also known. These are also available in pelletized form, with typical pellet properties including

Molecular sieve type 13X, a commercially available form of sodium zeolite, is an example of a zeolitic high-surface-area material useful for sulfur adsorption. Powdered zeolites of this type are currently used for the removal of H₂S and mercaptans from liquid and hydrocarbon fractions, and for the sweetening of natural gas streams containing H₂S, mercaptans, and thiophenes. A particular sodium zeolite useful for structured adsorbent manufacture is Zeochem Type 13X zeolite powder, commercially available from Zeochem, USA Division. In powder form this product has a surface area of about 514 m²/g and an average particle size of about 3 μm, and is of the chemical formula: 5Na₂O.5Al₂O₃.14SiO₂.XH₂O.

Extrusion batches for each of these adsorbent types are reported in Table 5 below. The compounding and extrusion of these batches to form adsorbent honeycomb structures may be carried out following the same processes as employed for the production of the Ni/NiO monoliths described in Example 1 above. The alumina and methyl cellulose binders, oleic acid emulsion and metal stearate lubricants employed in these batches are the same as or functionally equivalent to those employed in Example 1.

TABLE 5
Honeycomb Adsorbent Batch Compositions

| Adsorbent Type | Batch Composition |
|---|---|
| Cr—Cu-active | 100 parts Cr—Cu—C powder, 25 parts alumina |
| carbon | binder; 10 parts oleic acid emulsion; 7 |
| | parts methyl cellulose binder; 70 parts |
| | water |
| ZnO | 100 parts of ZnO powder; 10 parts alumina |
| | binder; 33 Parts oleic acid emulsion; 5.5 |
| | parts cellulose binder; 8.86 parts water |
| Cu—ZnO | 100 parts of CuZnO powder; 10 parts alumina |
| | binder; 30 parts oleic acid emulsion; 5.5 |
| | parts cellulose binder; 10 parts water |
| Sodium zeolite | 100 parts of 13X zeolite powder; 20 parts |
| | oleic acid; 15 parts silicone resin; 6 parts |
| | cellulose binder; 1 part metal stearate |
| | lubricant; 64.3 parts water |

Honeycomb adsorbents are extruded from the above batches, and the wet green honeycombs are slowly dried and then fired to achieve structural consolidation. Peak firing temperatures of 350, 400, and 500° C. are employed in these cases to consolidate the honeycombs into unitary, crack-free adsorbent structures.

Representative examples of the honeycomb adsorbent structures provided from these batches are reported in Table 6 below. Included in Table 6 for each of the adsorbent types represented in Table 5 above are data including the cell densities of the honeycombs, in channels per inch² (cpsi), the channel wall thicknesses of the honeycombs, in inches×10³, honeycomb wall porosities as a percent, mean channel wall pore sizes in micrometers, the mercury intrusion pore volumes of the wall structures, in ml/gram, the surface areas of the wall materials, in m2/gram, and the modulus of rupture (MOR) strengths in pounds/in² of the consolidated honeycombs, where determined on individual samples. Also included are the corresponding properties where applicable, of the powdered or pelletized adsorbent materials used to make the honeycombs.

TABLE 6
Extruded Honeycomb Adsorbent Properties

| | | | | | | Sur- | |
|---|---|---|---|---|---|---|---|
| | Cell | Wall | | | | face | |
| | Den- | Thick- | Po- | | Pore | area | |
| Adsorbent | sity | ness | rosity | MPD | Volume | (m²/ | MOR |
| Structure | (cpsi) | (in × 10³) | (%) | (um) | (ml/g) | g) | (psi) |
| Cr—Cu- | | | | | | | |
| active | | | | | | | |
| carbon | | | | | | | |
| Pellets | — | — | 23.4 | 0.48 | — | 632.1 | — |
| Honeycomb | 200 | 22 | 36.07 | 0.13 | — | 602.2 | 103 |
| ZnO | | | | | | | |
| Pellets | — | — | 49.66 | 0.028 | 0.245 | 52.18 | — |
| Honeycomb | 800 | 12 | 50.88 | 0.031 | 0.253 | 54.08 | — |
| Honeycomb | 200 | 22 | 55.61 | 0.032 | 0.266 | 53.52 | — |
| Honeycomb | 1800 | 8 | 51.32 | 0.032 | 0.246 | 55.03 | — |
| Cu—Zn—O | | | | | | | |
| Pellets | — | — | 43.75 | 0.03 | 0.20 | 63.96 | — |
| Honeycomb | 200 | 22 | 46.87 | 0.03 | 0.23 | 61.28 | 581 |
| Zeolite | | | | | | | |
| (13X) | | | | | | | |
| Powder | — | — | — | — | — | 514.2 | — |
| Honeycomb | 200 | 22 | 43.67 | 0.412 | 0.425 | 508.2 | 153 |

As is evident from a study of the data in Table 6, each of the various types of adsorbent materials evaluated above forms structured adsorbents of honeycomb geometry wherein the high surface areas and porosities of the starting adsorbents are substantially preserved. Thus these materials may be effectively converted to monolithic adsorbents of high geometric surface area yet low flow resistance without significantly affecting the inherent sulfur adsorption efficiencies of the materials themselves.

The above descriptions and examples are of course merely illustrative of the invention as hereinabove described, it being apparent from the breadth of the foregoing disclosure that numerous variations and modifications thereof may be practiced within the scope of the appended claims.

We claim:

1. A monolithic adsorbent structure for the desulfurization of a sulfur-containing fuel stream, the structure comprising internal void spaces bounded by internal adsorption surfaces, the internal surfaces supporting or containing an active sulfur adsorbent for extracting sulfur from a sulfur-containing fuel stream flowing through the internal void spaces.

2. A monolithic adsorbent in accordance with claim 1 consisting of a honeycomb structure wherein the internal void spaces comprise channels bounded by reactive adsorbent channel walls, and wherein the channel walls contain, or support a surface layer containing, one or more sulfur adsorbents selected from the group consisting of: (i) Mn, Fe, Zn, Co, Ni, Mo, Cu, Cr, W, and Ag active metals, (ii) oxides of the active metals, (iii) carbon, and (iv) zeolites.

3. A monolithic adsorbent in accordance with claim 2 wherein the honeycomb structure (i) is selected from the group of wall-flow structures and flow-through structures, (ii) has a cell density of at least 100 cpsi, and (iii) has an open frontal area in the range of 30-85% of the total cross-sectional area of the honeycomb entrance face.

4. A method for removing sulfur from a sulfur-containing fuel feed stream which comprises the step of conveying the feed stream through a monolithic adsorbent structure comprising internal void spaces bounded by internal adsorption surfaces, the internal surfaces supporting or containing an active sulfur adsorbent.

5. A method in accordance with claim 4 wherein the fuel feed stream is a liquid feed stream conveyed through the monolithic adsorbent structure at a liquid hourly space velocity of at least 1 hr⁻¹.

6. A method in accordance with claim 4 wherein the fuel feed stream is a gas feed stream conveyed through the monolithic adsorbent structure at a gas hourly space velocity of at least 500 hr⁻¹ and a feed stream temperature in the range of 25-400° C.

7. A desulfurization reactor for the removal of organic or inorganic sulfur from a sulfur-containing fuel feed stream, wherein the desulfurization is carried within a monolithic adsorbent packing structure comprising internal void spaces bounded by internal adsorption surfaces, the internal surfaces supporting or containing an active sulfur adsorbent.

8. A desulfurization reactor in accordance with claim 7 which extracts at least 70% of the sulfur present in a liquid fuel feed stream traversing the monolithic adsorbent packing structure at a liquid hourly space velocity of 1 hr⁻¹.

9. A desulfurization reactor in accordance with claim 7 which extracts at least 70% of the sulfur present in a gas fuel feed stream traversing the monolithic adsorbent packing structure at a gas hourly space velocity of 500 hr⁻¹.

10. A fuel reforming system incorporating a fuel reforming stage positioned downstream of a fuel desulfurization stage in the direction of fuel flow through the system, wherein the desulfurization stage comprises a reactor incorporating a monolithic sulfur adsorbent comprising internal channels bounded by internal channel walls supporting or containing an active sulfur adsorbent, the active sulfur adsorbent being one or more sulfur adsorbents selected from the group consisting of: (i) Mn, Fe, Zn, Co, Ni, Mo, Cu, Cr, W, and Ag active metals, (ii) oxides of the active metals, (iii) carbon, and (iv) zeolites.
